(19) United States
(12) Patent Application Publication
(10) Pub. No.: US 2010/0053248 A1
(43) Pub. Date: Mar. 4, 2010

(54) LIQUID EJECTING APPARATUS AND NOZZLE CHECK PATTERN FORMING METHOD

(75) Inventor: Yasushi AKATSUKA, Higashichikuma-gun (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/552,443

(22) Filed: Sep. 2, 2009

(30) Foreign Application Priority Data
Sep. 3, 2008 (JP) 2008-225639

(51) Int. Cl. B41J 29/38

(52) U.S. Cl. 347/14

(57) ABSTRACT

A liquid ejecting apparatus is provided, which includes: a head that ejects a first liquid and a second liquid having colors different from each other on a medium from a first nozzle and a second nozzle; and a control section that forms a nozzle check pattern constituted by the first liquid for checking poor liquid ejection from the first nozzle by landing the second liquid ejected from the second nozzle on the medium, and then landing the first liquid ejected from the first nozzle on the second liquid.

### BACKGROUND

The entire disclosure of Japanese Patent Application No. 2008-225639, filed Sep. 3, 2008, is expressly incorporated herein by reference.

1. Technical Field

The present invention relates to a liquid ejecting apparatus and a nozzle check pattern forming method.

2. Related Art

Liquid ejecting apparatus are already known, which have a head for ejecting liquid from nozzles, and a control section for forming a nozzle check pattern for checking poor liquid ejection from the nozzles on the medium, by ejecting the liquid ejected from the nozzles on a medium. A user of these liquid ejecting apparatus visually recognizes the aforementioned nozzle check pattern, and checks for poor liquid ejection (so-called, nozzle omission) from the nozzles due to clogging or the like of the nozzles (see, for example, JP-A-2007-168173).

However, when the color of liquid ejected from the nozzles, and the color of the medium (ground color) on which the nozzle check pattern for checking the poor liquid ejection from the nozzles is formed are close to each other, it may be difficult for a user to visually recognize the nozzle check pattern. In particular, when the color of the liquid and the ground color are the same color, it is further more difficult to visually recognize the nozzle check pattern. As a result, there is a possibility that a user is not able to check for poor liquid ejection from the nozzles appropriately.

### SUMMARY

An advantage of some aspects of the invention is that it provides a liquid ejecting apparatus and a nozzle check pattern forming method capable of appropriately checking for poor liquid ejection from the nozzles.

According to a first aspect of the invention, a liquid ejecting apparatus is provided, which includes: a head that ejects a first liquid and a second liquid having colors different from each other on a medium from a first nozzle and a second nozzle; and a control section that forms a nozzle check pattern constituted by the first liquid for checking poor liquid ejection from the first nozzle, by landing the second liquid ejected from the second nozzle on the medium and then landing the first liquid ejected from the first nozzle on the second liquid. The foregoing and other features of the invention are obvious by the specification and the accompanying drawings of the invention.

At least the next disclosures are obvious by the specification and the accompanying drawings of the invention.

First, the liquid ejecting apparatus of the invention includes: a head that ejects a first liquid and a second liquid having colors different from each other on a medium from a first nozzle and a second nozzle; and a control section that forms a nozzle check pattern constituted by the first liquid for checking poor liquid ejection from the first nozzle, by landing the second liquid ejected from the second nozzle on the medium and then landing the first liquid ejected from the first nozzle on the second liquid. With this liquid ejecting apparatus, even though the color of first liquid ejected from the first nozzle is the same color as the ground color of the medium, it is possible to check for poor liquid ejection from the first nozzle appropriately using the nozzle check pattern constituted by the first liquid.

Further, in the liquid ejecting apparatus, it is preferable that the medium is a white paper and the first liquid is a white liquid. In the configuration where the first liquid of white color is ejected from the first nozzle, when the nozzle check pattern constituted by the first liquid is formed at lower cost, it is possible to appropriately check for poor liquid ejection from the first nozzle using the nozzle check pattern.

Further, in the liquid ejecting apparatus, it is preferable that the control section forms an underlying portion constituted by the second liquid and having the same pattern as the nozzle check pattern, by landing the second liquid ejected from the second nozzle on the medium, and then forms the nozzle check pattern blotting out the underlying portion by landing the first liquid ejected from the first nozzle on the underlying portion. With this configuration, it is possible to reduce the consumption of the second liquid.

Further, in the liquid ejecting apparatus, it is preferable that the nozzle check pattern is composed of dots of the first liquid ejected from the first nozzle, the underlying portion is composed of dots of the second liquid ejected from the second nozzle, and the control section forms the dots of the first liquid to be larger than the dots of the second liquid. With this configuration, it is possible to further more reduce the consumption of the second liquid.

Further, in the liquid ejecting apparatus, it is preferable that the control section forms the underlying portion constituted by the second liquid, by landing the second liquid ejected from the second nozzle on the medium, and then forms the nozzle check pattern surrounded by the underlying portion by landing the first liquid ejected from the first nozzle on the underlying portion. With this configuration, the nozzle check pattern will stand out and thereby a user can easily obtain visual recognition.

Furthermore, according to a second aspect to the invention, a method of forming a nozzle check pattern is provided, which include: landing a second liquid, which is ejected from a second nozzle out of a first nozzle and the second nozzle ejecting a first liquid and the second liquid having colors different from each other, on a medium, and forming a nozzle check pattern constituted by the first liquid for checking poor liquid ejection from the first nozzle, by landing the first liquid ejected from the first nozzle on the second liquid. With the nozzle check pattern formed by this method, even though the color of first liquid ejected from the first nozzle is the same color as the ground color of the medium, it is possible to appropriately check for poor liquid ejection from the first nozzle using the nozzle check pattern.

### BRIEF DESCRIPTION OF THE DRAWINGS

The invention will be described with reference to the accompanying drawings, wherein like numbers reference like elements.

FIG. 1 is a block diagram showing the whole configuration of a printer.

FIG. 2A is a schematic view showing the internal configuration of the printer, and FIG. 2B is a cross-sectional view the internal configuration of the printer.

FIG. 3 is a view showing the arrangement of nozzles.

FIG. 4 is a flow chart showing print processing.

FIG. 5 is an explanatory diagram showing print data generation processing.

FIG. 6 is a view showing a setting screen of a printer driver.

FIG. 7 is a view showing a utility screen.

FIG. 8A is a view showing a nozzle check pattern NP (K) formed on a test sheet.

FIG. 8B is an enlarged view showing one block BP (K).

FIG. 9A and FIG. 9B are explanatory diagrams relating to a nozzle check method using a nozzle check pattern NP.

FIG. 10 is a view showing a flow of nozzle check pattern forming process of the embodiment.

FIG. 11A is the first explanatory diagram in connection with a procedure for forming the nozzle check pattern NP relating to the white ink nozzle in the nozzle check pattern forming process of the embodiment.

FIG. 11B is the second explanatory diagram in connection with a procedure for forming the nozzle check pattern NP relating to the white ink nozzle in the nozzle check pattern forming process of the embodiment.

FIG. 12A is a view showing an underlying piece.

FIG. 12B is a view showing a block BP (W) constituting the nozzle check pattern NP (W) relating to the white ink nozzle.

FIG. 13 is a view showing a cleaning setting screen.

FIG. 14 is a view showing a background image and the nozzle check pattern NP (W) relating to the white ink nozzle which are formed in the nozzle check pattern forming process according to the modified example.

### DESCRIPTION OF EXEMPLARY EMBODIMENTS

### Configurations of the Liquid Ejecting Apparatus of the Embodiments

In the embodiment, as an example of the liquid ejecting apparatus, an ink jet printer (hereinafter, referred to as a printer 10) will be described.

### The Basic Configuration of the Printer 10

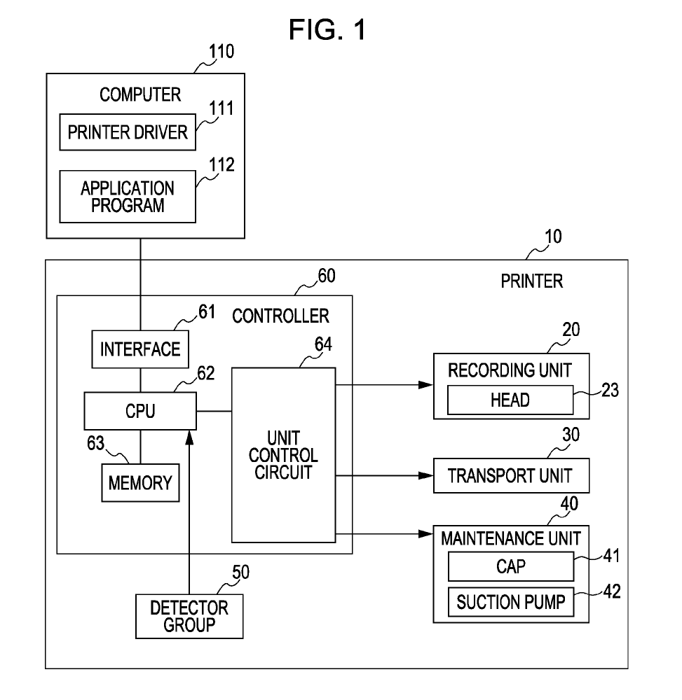

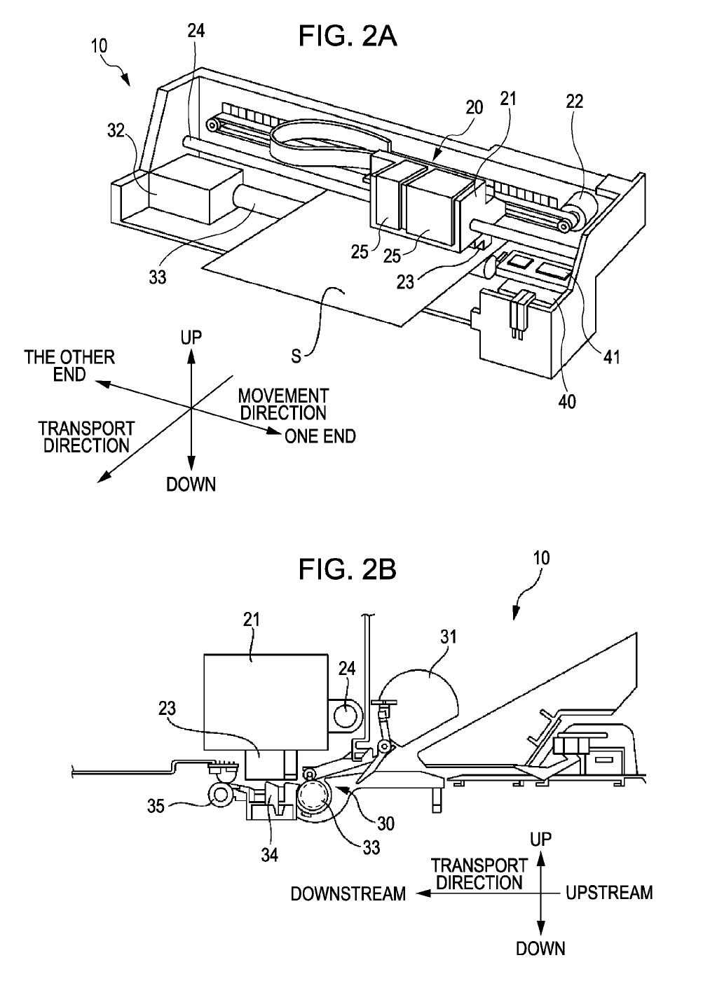

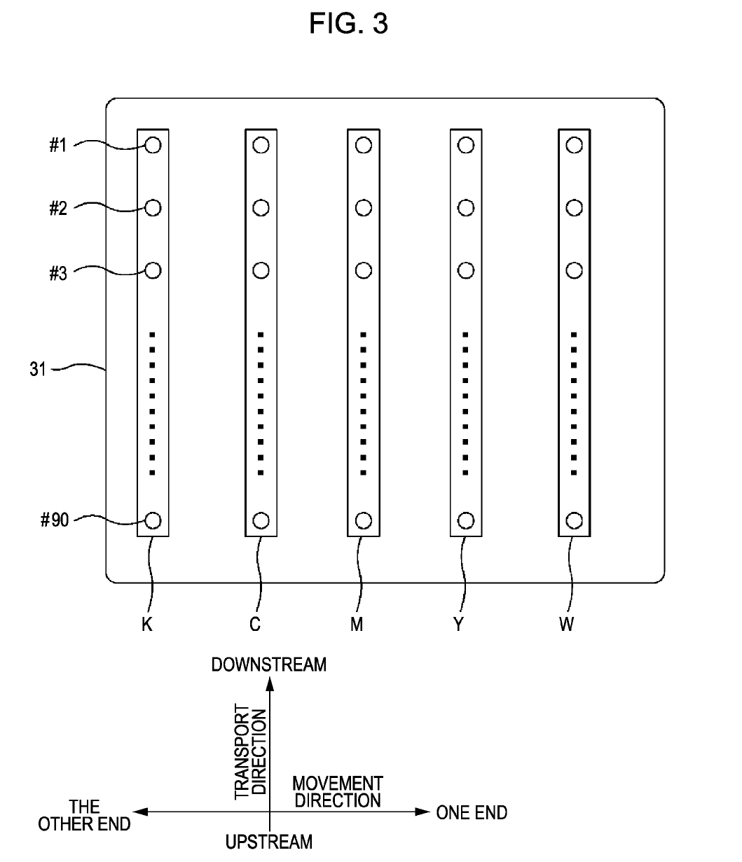

First, reference is made to FIG. 1 to FIG. 3 to describe the basic configuration of the printer 10. FIG. 1 is a block diagram showing the whole configuration of the printer 10. FIG. 2A is a schematic view showing the internal configuration of the printer 10, and FIG. 2B is a cross-sectional view showing the internal configuration of the printer 10. In FIG. 2A, the movement direction of a head 23 and the transport direction of a medium S are indicated by the arrows, and in FIG. 2B, the transport direction is indicated by the arrow. FIG. 3 is a view showing the arrangement of nozzles, and the arrows of the same drawing show the movement direction and the transport direction of the head 23.

The printer 10 is an apparatus in which ink as an example of liquid is ejected onto a medium S such as paper, textile, film sheets and the like (see FIG. 2A and FIG. 2B) to thereby form (print) an image on the medium S. Ink may be any of aqueous or oily inks. The printer 10 executes the printing of a color image by ejecting color ink of the 4 CMYK colors.

Moreover, in the printer 10 of the embodiment, white ink is ejected in addition to color ink of the 4 CMYK colors. This white ink is ink by which a solid setting is performed on the film sheet so as to print a background image, for example, when a colorless and transparent film sheet is used as a medium S. In other words, color ink of the 4 CMYK colors is overstriked on a background image constituted by white ink in the embodiment, so that a color image can be printed on the background image. In addition, when overlapped with other inks, white ink according to the embodiment is not mixed with such other inks (not blended with).

As shown in FIG. 1, the printer 10 includes a recording unit 20, a transport unit 30, a maintenance unit 40, a detector group 50, and a controller 60 used as an example of a control section.

The recording unit 20 records an image in the medium S, and includes a carriage 21, a carriage movement mechanism 22, and a head 23, as shown in FIG. 2A and FIG. 2B. The carriage 21 is reciprocated along a guide axis 24 by the carriage movement mechanism 22, in a state supported against the guide axis 24 which intersects with the transport direction described later.

The head 23 includes a lower surface on which the nozzles are formed (hereinafter, referred to as a nozzle surface), and ejects ink, which is supplied from an ink cartridge 25 mounted in the carriage 21, from the nozzles to the medium S, with the nozzle surface facing the medium S. Further, the head 23 is mounted in the carriage 21, and moved in the same direction as the direction where the carriage 21 is moved in accordance with the movement of the carriage 21. In other words, the movement direction of the carriage 21 is equivalent to the movement direction of the head 23. The head 23 is configured so as to face the nozzle surface to the medium S by moving in the movement direction.

As shown in FIG. 3, the nozzles with each ink color (in the embodiment, yellow ink nozzle, magenta ink nozzle, cyan ink nozzle, black ink nozzle, and white ink nozzle) are formed in the nozzle surface of the head 23. The nozzles of the embodiment are composed of nozzle holes that are each formed in plural numbers (in the embodiment, the number of 90) for each ink color. The plural nozzle holes make rows side by side at uniform nozzle pitches in the direction intersecting with the movement direction of the head 23 (that is, transport direction described later). Further, the nozzle holes of each nozzle are numbered with smaller numbers as the nozzle holes go further along the downstream side (#1 to #90). In other words, the nozzle hole #1 is located further along the downstream side of the transport direction than the nozzle hole #90 is. The nozzle holes having the same numbers among each of the ink colors are located at the substantially same position with respect to the transport direction.

Further, each of the nozzle holes is provided with an ink chamber and a piezo element which are not shown, and the ink chamber is contracted and expanded by the driving of the piezo element, and thereby eject droplet-like ink from each of the nozzle holes. In addition, the ejection of ink from the nozzles is performed while the head 23 is moving in the movement direction in accordance with the movement of the carriage 21 (in the embodiment, while the head is moving from one end of the movement direction to the other end thereof). The ejected droplet-like ink forms dots when it landed on the medium S.

The transport unit 30 is a device for transporting the medium S in the transport direction shown in FIG. 2A and FIG. 2B. Here, the transport direction is along the direction where a plurality of nozzle holes, which constitute the corresponding nozzles in the nozzles of each ink color, are lined up. This transport unit 30 includes a paper feed roller 31, a transport motor 32, a transport roller 33, a platen 34, and a paper discharge roller 35, as shown in FIG. 2A and FIG. 2B. When the medium S is supplied into the printer 10 by the paper feed roller 31, it is transported up to a region capable of printing in the transport direction by the transport roller 33 which is rotated due to the rotation of the transport motor 32. Thereafter, medium S is intermittently transported by a prescribed transport amount while being supported to the platen 34, and eventually discharged to the outside of the printer 10 by the paper discharge roller 35.

In addition, the transport unit 30 of the embodiment rotates the transport roller 33 in the direction opposite to a positive rotation direction (inverted direction), so that it can return the medium S, which is transported from the upstream of the transport direction to the downstream thereof, to the upstream side again. Herewith, a part of the medium S having already passed through under any nozzle holes is located to the downside of any nozzle holes again, so that ink ejected from any nozzle holes mentioned above can be landed on the part. According to this configuration, for example, after a background image is printed on the medium S in ink of any colors, an image can be formed on the background image using ink of other colors.

The maintenance unit 40 is a device for performing various types of maintenance operations in order to maintain the good ejection of ink from the head 23 to the medium S. As shown in FIG. 2A, the maintenance unit 40 is located substantially directly under the head 23, when the head 23 is located at a position in which the nozzle surface does not face the medium S (in other words, which is a nonprinting position, and also a position in readiness of the head 23) in the movement direction of the head 23. Further, the maintenance unit 40 includes a cap 41 and a suction pump 42, as shown in FIG. 1. The cap 41 seals the nozzles (in particular, each of the nozzle holes) in close contact with the nozzle surface of the head 23. Further, the suction pump 42 operates in a state where the cap 41 seals the nozzles, and creates a negative-pressure state inside of the cap 41, to thereby suck ink within the nozzles and forcibly discharge it.

The maintenance unit 40 of the above-mentioned configuration executes a cleaning operation where ink within the nozzles is forcibly discharged by the suction pump 42 as a maintenance operation, with the nozzles sealed by the cap 41. Executing such a cleaning operation allows the nozzles which may be in a state of poor ink ejection due to the clogging or the like to be cleaned (poor ejection of ink is resolved). Further, the cleaning operation includes an operation (so-called flushing operation) for driving the piezo elements of each nozzle hole so as to forcibly eject ink from each nozzle hole, with the nozzles sealed by the cap 41, in addition to an operation for driving the suction pump 42 to forcibly discharge ink within the nozzles, with the nozzles sealed by the cap 41.

The controller 60 controls each of the units of the printer 10 (that is, recording unit 20, transport unit 30, and maintenance unit 40) via a unit control circuit 64 by a CPU 62, in accordance with a program stored in a memory 63. The controller 60 is capable of communicating with a computer 110 via an interface 61. If print data are received from the computer 110, the controller controls each of the units on the basis of the print data so as to print an image in accordance with the print data on the medium S. Further, the status in the printer 10 is monitored by the detector group 50, and the detector group 50 outputs a signal in accordance with the detection result toward the controller 60.

### With Respect to Print Processing

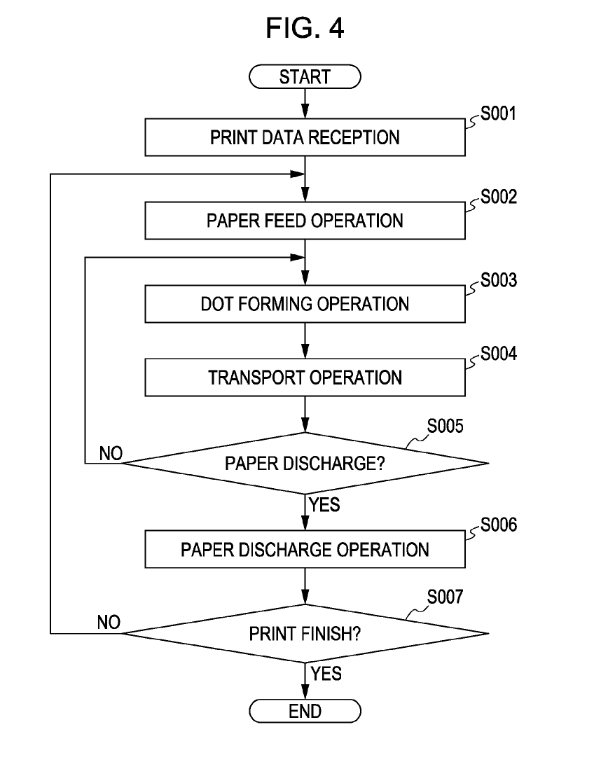

Next, print processing which the printer 10 executes will be described with reference to FIG. 4. FIG. 4 is a flow chart showing the print processing.

As shown in FIG. 4, the print processing begins at the time the controller 60 receives the print data including printing instructions from the computer 110 via the interface 61 (S001). The controller 60 analyzes contents of various types of commands in the received print data, and controls each of the units of the printer 10. Next, the controller 60 supplies the medium S to the printer 10 by the paper feed roller 31, and then performs a paper feed operation where the medium S is positioned at a print starting position (cueing position) by the transport roller 33 (S002).

Next, the controller 60 performs a dot forming operation where ink is intermittently ejected from the nozzles of the head 23 moving with the movement of the carriage 21 so as to form dots on the medium S (S003). The dots are formed by landing the ink drops on a square-shaped region (hereinafter, unit region) virtually determined on the medium S. The unit region has a size or a shape thereof determined depending on the print resolution. When the ink drops are ejected ideally, the ink drops are landed on a center position of the unit region, and thereafter the ink drops extends to thereby form the dots on the unit region. In the dot forming operation, since ink is intermittently ejected from the nozzles of the moving head 23, dot rows (Rasta line) arranged along the movement direction of the head 23 are formed on the medium S in plural lines in the transport direction.

Next, the controller 60 performs a transport operation where the medium S is relatively moved with respect to the head 23 in the transport direction by the transport unit 30 (S004). It is possible to form, by the transport operation, the Rasta line through the next dot forming operation on a position different from the position of the Rasta line formed through the previous dot forming operation. The controller 60 repeatedly executes the dot forming operation and the transport operation, so that the plural Rasta lines are formed in the transport direction. In the embodiment, an interlaced process is adopted where the Rasta line is formed by the multi-cycle dot forming operations in a complementary manner.

The controller 60 repeats the dot forming operation and the transport operation until the print data for printing on the medium S has been exhausted, and determines whether to discharge the paper at the point of the exhaustion of the print data (S005). Thereafter, the controller 60 performs the paper discharge operation where the medium S is discharged to the outside of the printer 10 by the paper discharge roller 35 (S006). After the medium S on which an image is printed is discharged to the outside of the printer 10, the controller 60 performs the determination of whether to proceed with the printing (S007). If the printing is performed on the next medium S, the controller 60 returns to the above-described paper feed operation and proceeds with the printing. On the other hand, if the printing is not performed on the next medium S, print processing is finished.

### With Respect to the Computer 110

Next, the computer 110 connected to the printer 10 will be described. The computer 110 outputs executive instructions other than print data for various types of operations (for example, cleaning operation) executed within the printer 10 toward the printer 10. As shown in FIG. 1, programs such as a printer driver 111 or an application program 112 are installed in this computer 110.

The printer driver 111 receives image data from the application program 112, converts the image data into print data, and outputs the print data toward the printer 10. The print data have data (hereinafter, pixel data) relating to pixels constituting an image to be printed (print image). These pixel data are, for example, data (data such as a color or a size of the dots) relating to the dots formed on the unit region corresponding to any of the pixels.

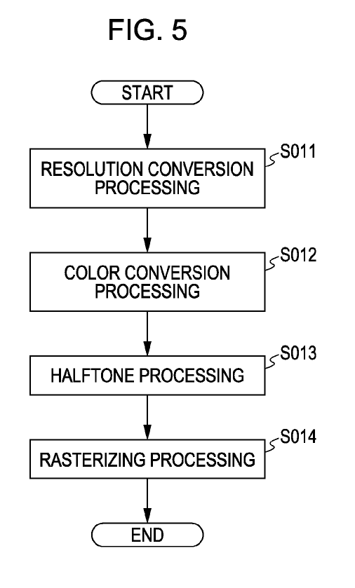

Hereinafter, reference is made to FIG. 5 so as to describe print data generation processing by the printer driver 111. FIG. 5 is an explanatory diagram showing print data generation processing. As shown in FIG. 5, the print data are generated by the executions of resolution conversion processing (S011), color conversion processing (S012), halftone processing (S013), and rasterizing processing (S014) by the printer driver 111.

The resolution conversion processing is processing for converting the resolution of RGB image data output from the application program 112 into the print resolution corresponding to a specified image quality. The color conversion processing is processing for converting the RGB image data having the converted resolution thereof into the image data of 4 CMYK colors. A plurality of pixel data constituting each of the image data is represented by 256-level grayscale values.

The halftone processing is processing for converting multi-level grayscale values that the pixel data represent into small-level dot grayscale values capable of being represented by the printer 10. That is, in the halftone processing, 256-level grayscale values that the pixel data represent are converted into 4-level dot grayscale values. In particular, they are converted into four levels with respect to non-dots corresponding to the dot grayscale value [00], the formation of small dots corresponding to the dot grayscale value [01], the formation of medium dots corresponding to the dot grayscale value [10], and the formation of large dots corresponding to the dot grayscale value [11]. Thereafter, the dot formation ratios are determined with respect to sizes of each dot, and then the pixel data are created so that the printer 10 disperses and forms the dots, using a dither method, a γ correction, an error diffusion method and the like.

The rasterizing processing is processing for changing the data of each dot (data of dot grayscale values) in order for data to be transferred to the printer 10 in terms of the image data obtained by the halftone processing. The rasterizing processed data are transmitted as a portion of the print data.

When a background image is formed and an image (original image) is formed on the background image, the printer driver 111 generates both the print data of the original image and the print data of the background image by the above-mentioned order, and transmits both toward the printer 10.

### Settings by Printer Driver 111

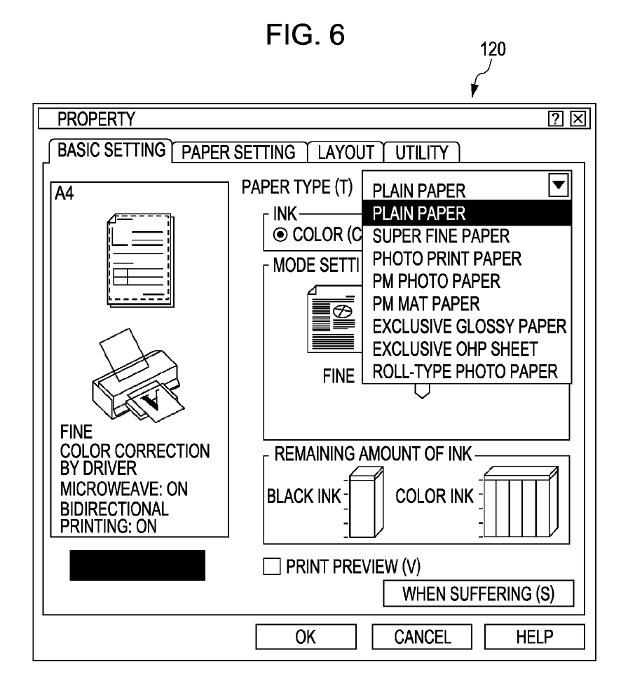

The printer driver 111 displays a setting screen 120 shown in FIG. 6 on a display (not shown) of the computer 110 in order to receive a setting operation of printing conditions by a user. FIG. 6 is a view showing the setting screen 120. A user can select various types of the printing conditions (print resolution, type and size of the medium S and the like) via the setting screen 120. The printer driver 111 generates the print data in accordance with the selected printing conditions.

In addition, the setting screen 120 changes in accordance with the classes of the setting contents. The setting screen 120 shown in FIG. 6 can be changed over to a screen for basic setting, a screen for paper setting, a screen for layout setting, and a screen for utility setting. A user can make the printer 10 print a nozzle check pattern for checking for poor liquid ejection from the nozzles via the screen for utility setting (hereinafter, utility screen 122) in the setting screen 120. Further, a user can also execute a cleaning operation by the maintenance unit 40 via the utility screen 122. The nozzle check pattern will be described later.

### With Respect to Nozzle Check Pattern

When an image is printed on the medium S by the print processing using the printer 10, ink may not be ejected from some of the nozzles, and the dots may not be appropriately formed on the unit region of the medium S on which the dots should be formed by ink ejected from any of the nozzles mentioned above. Such a phenomenon is called a nozzle omission phenomenon, and it is part of the reason that the quality of a print image degrades. Such a nozzle omission phenomenon occurs due to a state where the nozzles are poorly ejected on the ground of clogging of the nozzle holes or the like.

In order to avoid the degradation of image quality by this nozzle omission phenomenon, a user checks the poor ink ejection of each nozzle periodically, and if required (that is, when determining that the nozzles are in a state of poor ink ejection), a user executes the above-described cleaning operation. In checking the poor ink ejection of the check object nozzles, processing is performed for landing ink ejected from the check object nozzles on a predetermined medium (hereinafter, test sheet TS) to form the nozzle check pattern NP on the test sheet TS. A user visually recognizes the nozzle check pattern NP, and so forth, and thereby checks whether the check object nozzles are in a state of poor ink ejection.

Hereinafter, a reference example for a method of forming the nozzle check pattern NP (hereinafter, simply referred to as a reference example) will be described using the printer 10, and further the problem of the reference example will be described.

### With Respect to Reference Examples

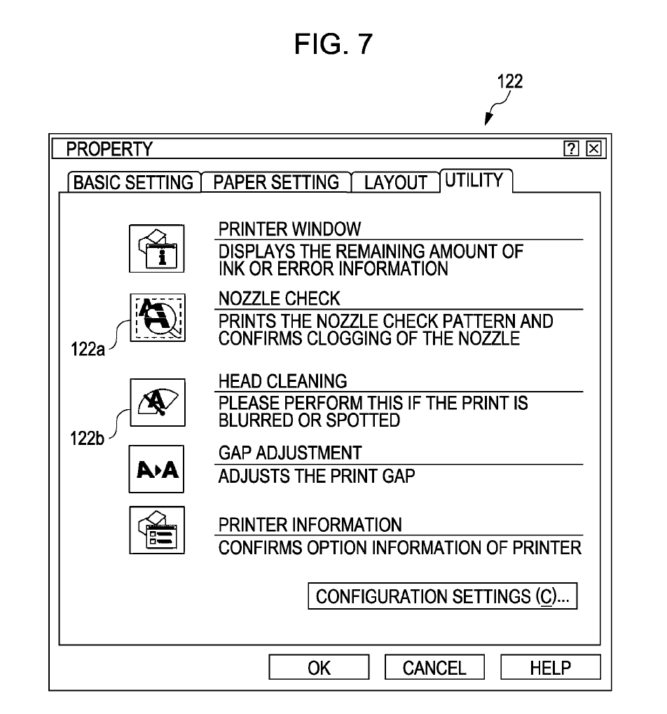

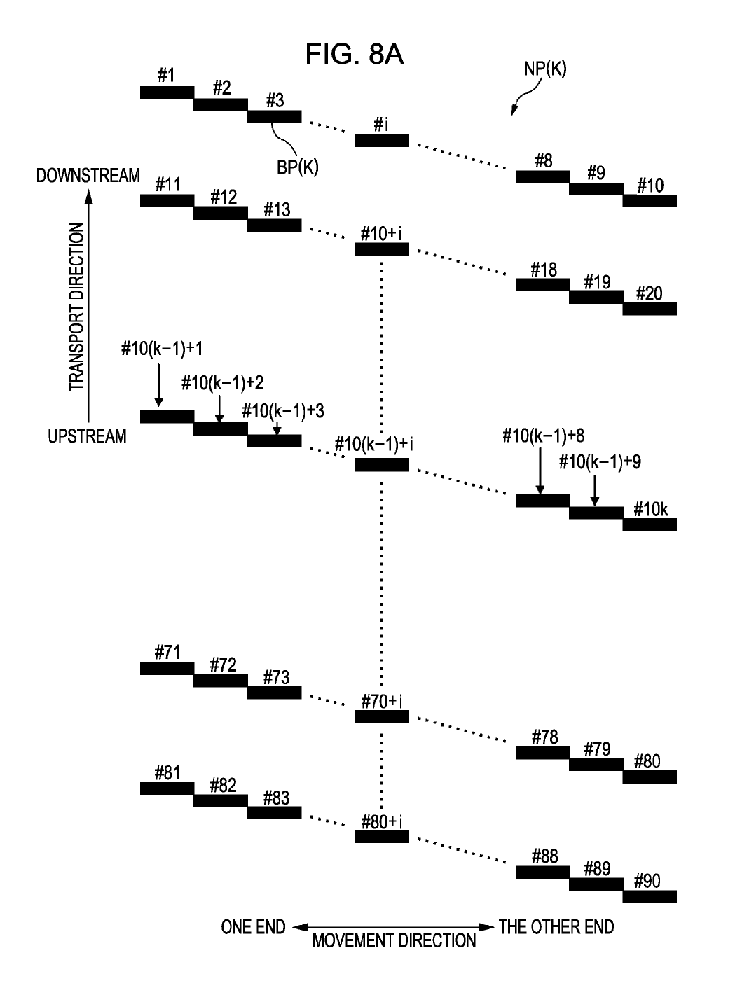

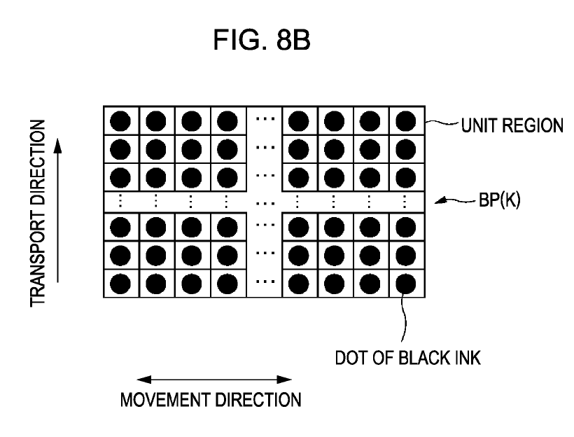

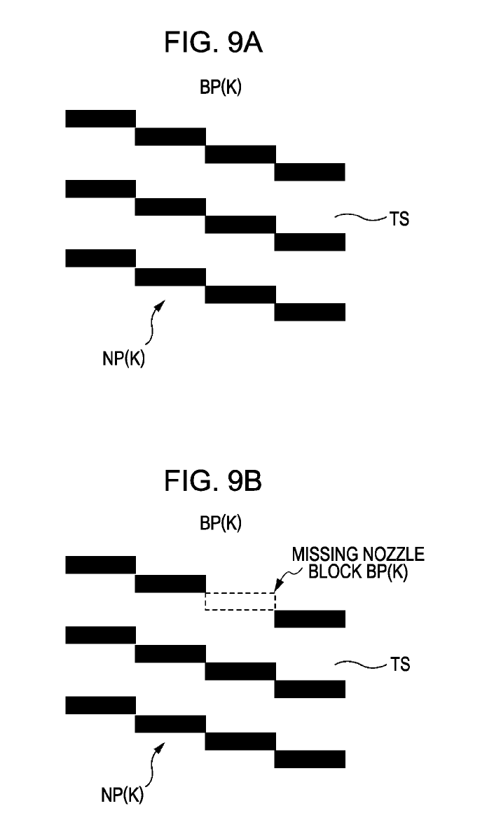

The reference example will be described with reference to FIG. 7, FIG. 8A, FIG. 8B, FIG. 9A, and FIG. 9B. FIG. 7 is a view showing the above-described utility screen 122. FIG. 8A is a view showing the nozzle check pattern NP (K) for checking for poor ink ejection from the black ink nozzle. FIG. 8B is an enlarged view showing a block BP (K) constituting the nozzle check pattern NP (K). In FIG. 8A and FIG. 8B, the direction equivalent to the transport direction (in the drawing, simply represented as the transport direction), and the direction equivalent to the movement direction of the head 23 (in the drawings, simply represented as the movement direction) are indicated by the arrows. FIG. 9A and FIG. 9B are explanatory diagrams of a nozzle check method using the nozzle check pattern NP. FIG. 9A is a view showing the case where the nozzle check pattern NP is appropriately formed, and FIG. 9B is a view showing the case where a portion of the nozzle check pattern NP is missing.

The controller 60 of the printer 10 lands ink ejected from each of the nozzles on the test sheet TS, and thereby forms the nozzle check pattern NP for checking the poor ink ejection from each of the corresponding nozzles (hereinafter, referred to as the nozzle check pattern NP relating to each of the nozzles). In the reference example, the nozzle check patterns NP relating to each of the nozzles are printed in a single color by ink ejected from the each of the corresponding nozzles. For example, the nozzle check pattern relating to the black ink nozzle is printed in a single color in only black ink.

Further, in the reference example, the above-mentioned nozzle check patterns NP are formed with each ink color. Since forming procedure of the nozzle check patterns NP according to the reference example is similar to that of between ink colors, the nozzle check pattern NP (K) relating to the black ink nozzle, hereinafter, will be described by way of example.

In the reference example, at the time of forming the nozzle check pattern NP relating to the nozzles of each ink color beginning with the black ink nozzle, a user sets the test sheet TS in the printer 10, and clicks a nozzle check button 122a (see FIG. 7) displayed on the utility screen 122. By this clicking manipulation, the printer driver 111 receives a user request for execution of the nozzle check pattern formation, and transmits instructions to the printer 10 for forming the nozzle check pattern NP by the printer 10. That is, the printer driver 111 generates the print data for forming the nozzle check patterns NP of each ink color on the test sheet TS, and outputs such print data toward the printer 10.

If the controller 60 receives the print data, the controller repeatedly executes the dot forming operation and the transport operation described above, on the basis of the print data of the nozzle check pattern NP (K) relating to the black ink nozzle among these print data. In other words, the controller 60 lands black ink ejected from the black ink nozzle on the test sheet TS, thereby forming the nozzle check pattern NP (K) relating to the black ink nozzle.

The nozzle check pattern NP (K) relating to the black ink nozzle is constituted by black ink, and each of the colors thereof is the color of black ink (that is, black). Further, the nozzle check pattern NP (K) relating to the black ink nozzle is composed of the blocks in the same number (the number of 90 in the embodiment) as that of the nozzle holes constituting the black ink nozzle, as shown in FIG. 8A. To explain it more specifically, as shown in FIG. 8A, the rectangular-shaped blocks BP (K) are lined up in steps in the number of m (10 in an example shown in FIG. 8A) in the direction equivalent to the movement direction of the head 23, and in the number of n (nine in an example shown in FIG. 8A) for each regular interval along the direction equivalent to the transport direction.

The nozzle check pattern NP (K) corresponds to the nozzle to be checked concerning whether it is in a state of poor ink ejection through the visual recognition by a user (namely, it is the check object nozzle, and in particular, the black ink nozzle). Each of the blocks BP of the nozzle check pattern NP (K) correspond to the black ink nozzle holes constituting the black ink nozzle that is the check object. To explain the correspondence relationship, the block BP (K), which are located at the extreme of the downstream side in the direction equivalent to the transport direction and locates at the extreme of one end side in the direction equivalent to the movement direction of the head 23, corresponds to the black ink nozzle holes of #1 (that is to say, this is for checking for poor ink ejection from the black ink nozzle holes of #1). As shown in FIG. 8A, the i-th and k-th block BP (K) corresponds to the black ink nozzle hole of #10(k−1)+i, where the i-th is a position viewed from the block BP (K) locating at the extreme of one end side in the direction equivalent to the movement direction of the head 23, and the k-th is a position viewed from the block BP (K) locating at the extreme of the downstream side in the direction equivalent to the transport direction.

When focusing attention on one of a plurality of blocks BP (K) constituting the nozzle check pattern NP (K) a plurality of dots is composed of p dots lined up along the direction equivalent to the movement direction of the head 23, and q dots lined up along the direction equivalent to the transport direction, as shown in FIG. 8B. In the reference example, each of the dots constituting the block BP is formed in order so as to be the medium dots. That is, when the print data for forming the nozzle check pattern is generated, the printer driver 111 sets the dot grayscale value of each pixel data constituting the image data of the nozzle check pattern NP (K) to [10].

In a single dot forming operation (moving operation from one end of the moving range of the head 23 to the other end thereof), one dot group of q dot groups is formed lined up in the transport direction (each of the dot groups are composed of p dots lined up in the movement direction of the head 23). For this reason, to form q dot groups in the transport direction (that is, for the purpose of forming the block BP), the dot forming operation and the transport operation are alternately repeated q times. On this occasion, for example, if one dot is large, and the block BP is formed in order to easily confirm whether the dot is formed, q may be 1. In such a case, the block BP is formed by a single dot forming operation.

After this nozzle check pattern NP (K) is formed on the test sheet TS, a user visually recognizes the nozzle check pattern NP (K), and thereby checks for poor ink ejection from the black ink nozzle. To explain it specifically, as shown in FIG. 9A, when the nozzle check pattern NP (K) is formed which composed of the blocks BP (K) in the same number as that of the nozzle holes constituting the black ink nozzle, the black ink nozzle is determined to be normal (that is, there are no black ink nozzle holes which are in a state of the poor ink ejection).

On the other hand, when a portion of the nozzle check pattern NP (K) is missing as shown in FIG. 9B, the black ink nozzle is determined to be in a state of poor ink ejection. In other words, when the block BP (K) is not actually formed on a portion where the block BP (K) in the nozzle check pattern NP (K) should be formed in the test sheet TS, and the portion remains the same as the ground color of the test sheet TS, the occurrence of nozzle omission is determined in the nozzle hole corresponding to the block BP (K) which has not been formed.

When a user determines that there is a nozzle in a state of poor ink ejection, the user clicks a cleaning button 122b (see FIG. 7) displayed on the utility screen 122. By this clicking manipulation, the printer driver 111 receives a user request for execution of the cleaning operation, and outputs instructions for executing the cleaning operation by the maintenance unit 40 on the printer 10. The controller 60 of the printer 10 executes the cleaning operation on receiving the instructions.

Thereafter, in order to confirm whether the poor ink ejection of the nozzle is solved by the cleaning operation, the nozzle check pattern NP is once again printed on the test sheet TS, following the execution of the cleaning operation. Until a user can visually recognizes certainly the solution of poor ink ejection of the nozzle, the user repeatedly executes the cleaning operation and the formation of the nozzle check pattern NP.

### With Respect to Problems of Reference Examples

In the reference example, the nozzle check pattern NP is formed (printed) on the test sheet TS for each ink color according to the procedure. Further, in the reference example, the pattern having the same color as that of ink ejected from each of the nozzles is formed as the nozzle check pattern NP relating to each of the nozzles, as described above. In other words, the nozzle check pattern NP relating to each of the nozzles is printed in a single color using ink ejected from each of the nozzles.

In the reference example, since the nozzle check pattern NP relating to each of the nozzles is formed, the dots ejected from the nozzles are directly landed on the test sheet TS. It is difficult for a user to visually recognize the nozzle check pattern NP formed by such a method, when the color of the nozzle check pattern NP and the color of the test sheet TS (ground color) are close to each other. It is more difficult for a user to visually recognize, in particular, the nozzle check pattern NP formed in ink having the same color as the ground color. For example, when the nozzle check pattern NP constituted by white ink (in other words, nozzle check pattern NP (W) relating to the white ink nozzle) is formed on the test sheet TS of which the ground color is white, it is difficult for a user to visually recognize the nozzle check pattern NP by the naked eye. Hereinafter, such conditions will be described in more detail.

In the printer 10 configured to form the white ink nozzle on a nozzle surface of the head 23, white ink is used to print a background image on the transparent film sheet, as described above. The nozzle check pattern NP is formed in order to check whether the white ink nozzle is in a state of poor ink ejection, similarly to the nozzles of other ink colors. On the other hand, an inexpensive white paper (for example, plain paper) is, in general, used as a test sheet TS for the purpose of reducing costs required for the forming of the nozzle check pattern NP.

However, when the nozzle check pattern NP (W) relating to the white ink nozzle is formed by landing white ink on the test sheet TS which is a white paper, it is difficult for a user to visually recognize the nozzle check pattern NP (W) by the naked eye. In other words, since there is only small contrasts in the color of the nozzle check pattern NP and the ground color of the test sheet TS, it is highly possible that a user falsely recognizes that the nozzle check pattern NP (W) is not formed, even though the nozzle check pattern NP (W) is normally formed (In other words, although the nozzles are in a normal state, the nozzles may be determined to be in a state of poor ink ejection). On the contrary, even though a portion of the nozzle check pattern NP (W) is not actually formed due to poor ink ejection, there is a possibility that a user lets the white ink nozzle, which is in a state of poor ink ejection, be left as it is, without noticing the partial missing of the nozzle check pattern NP (W) because of the small contrasts mentioned above.

As described above, a user may not appropriately check the poor ink ejection relating to the nozzle (in particular, the nozzle from which ink having the same color as the ground color of the test sheet TS is ejected) in the nozzle forming pattern NP formed on the test sheet TS in the reference example. Especially, as described above, when the nozzle check pattern NP relating to the white ink nozzle is printed in a single color by using white ink on the test sheet TS with a white color, it is more difficult to check the poor ink ejection of the white ink nozzle. To solve such a problem, in the printer 10 of the embodiment, a method is adopted in which the nozzle check pattern NP relating to the nozzle for ejecting ink having the same color as the ground color of the test sheet TS is formed to be suitable for the nozzle check. Hereinafter, the method of forming the nozzle check pattern of the embodiment will be described.

### Method of Forming the Nozzle Check Pattern of the Embodiment

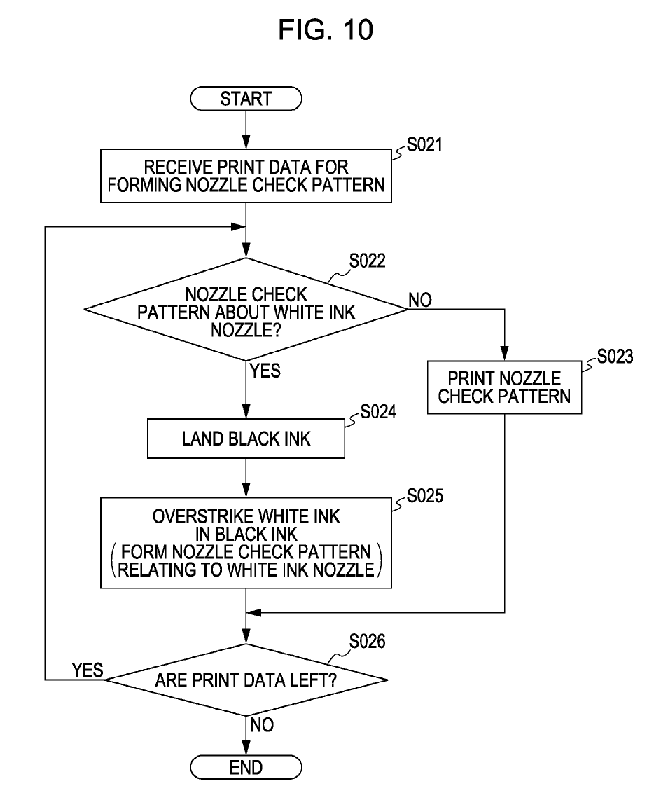

Reference is made to FIG. 10 to FIG. 12 to describe a nozzle check pattern forming method of the embodiment.

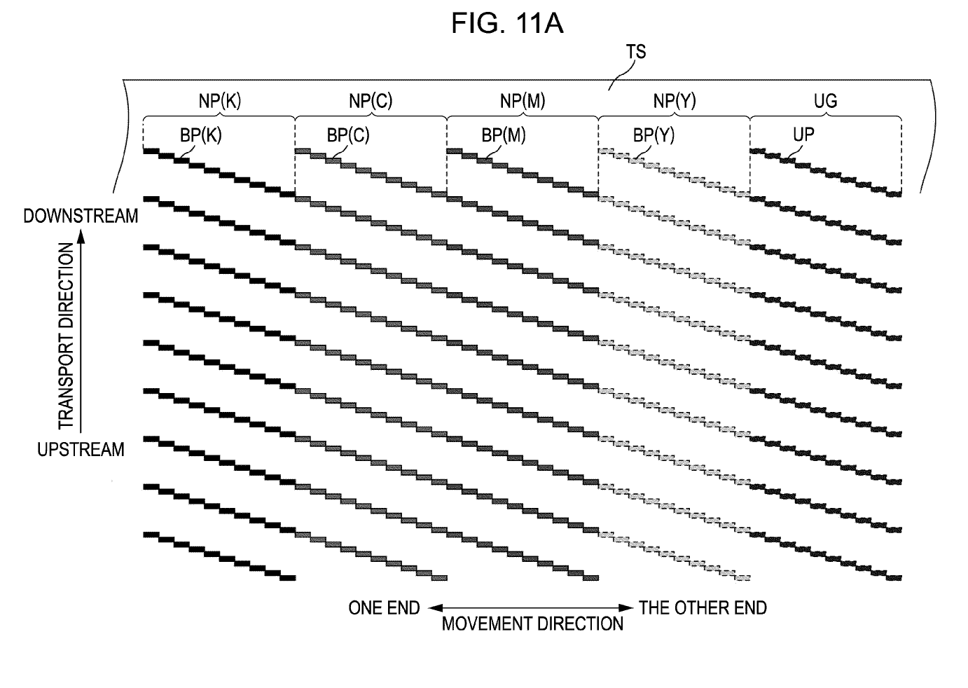

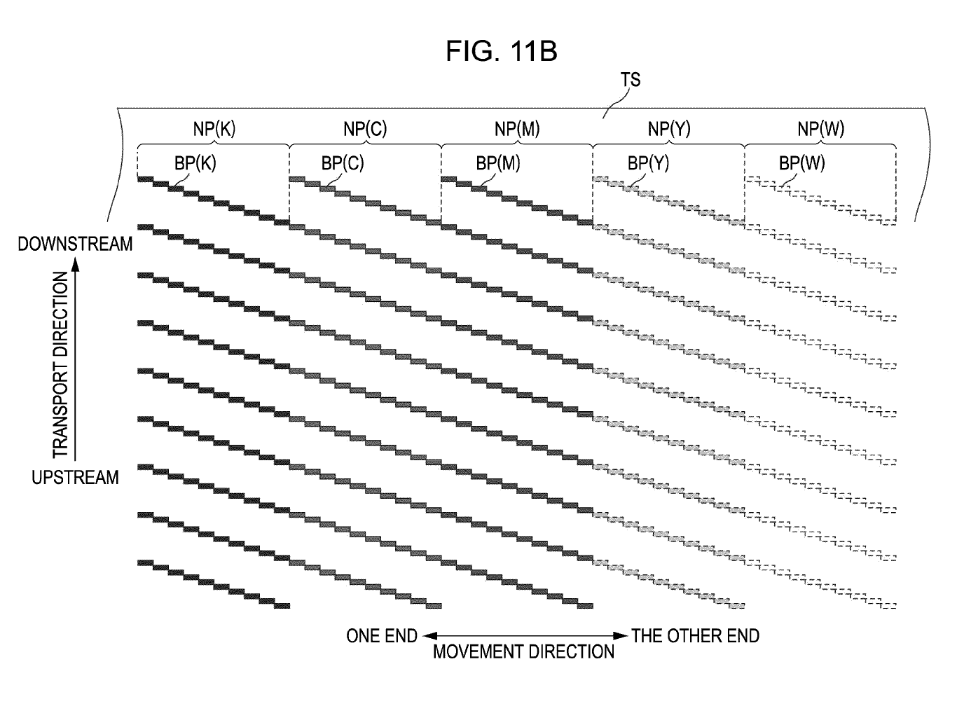

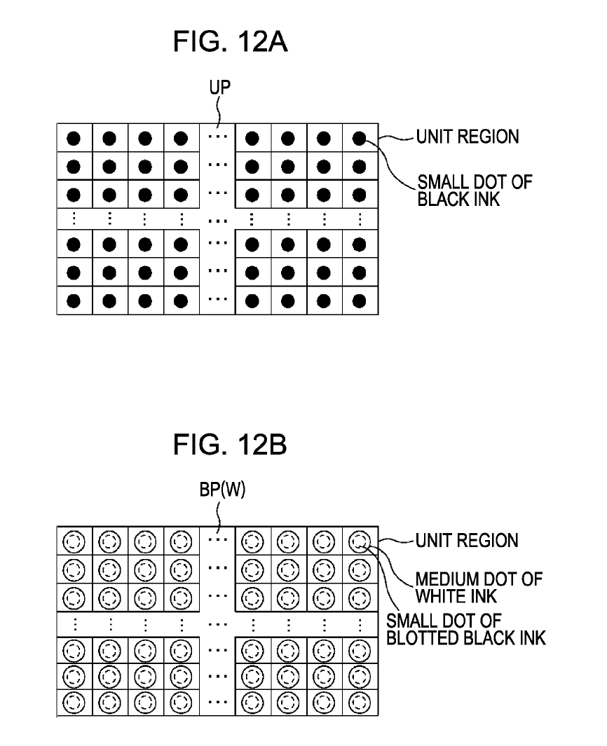

FIG. 10 is a view showing a flow of process for forming the nozzle check pattern NP by a nozzle check pattern forming method of the embodiment (hereinafter, nozzle check pattern forming process). FIG. 11A and FIG. 11B are explanatory diagrams in connection with a procedure for forming the nozzle check pattern NP relating to the white ink nozzle in the nozzle check pattern forming process. In FIG. 11A and FIG. 11B, the direction equivalent to the transport direction (in the drawings, simply represented as the transport direction), and the direction equivalent to the movement direction of the head 23 (in the drawings, simply represented as the movement direction) are indicated by the arrows. FIG. 12A is a view showing an underlying piece UP described later. FIG. 12B is a view showing a block BP (W) constituting the nozzle check pattern NP (W) relating to the white ink nozzle.

In a description mentioned below, the case where the nozzle check pattern NP is formed on the test sheet TS will be described by way of example, using a paper of which the ground color is white (in particular, plain paper) as a test sheet TS.

As shown in FIG. 10, the nozzle check pattern forming process of the embodiment begins at the time when the controller 60 of the printer 10 receives the print data for forming the nozzle check pattern from the printer driver 111 (S021). Similarly to the reference example, such print data are generated by the printer driver 111 using the click of the nozzle check button 122a on the utility screen 122 by a user as a trigger. Next, the controller 60 of the printer 10 repeatedly executes the dot forming operation and the transport operation on the basis of the received print data, thereby forming each of the nozzle check patterns NP on the test sheet TS. In the nozzle check pattern forming process of the embodiment, similarly to the reference example, the nozzle check patterns NP relating to each of the nozzles are then constituted by ink ejected from each of the nozzles.

Here, when forming the nozzle check patterns NP relating to each of the nozzles of the 4 CMYK colors (NO in S022), the controller 60 forms the corresponding nozzle check patterns NP by the same procedure as the procedure according to the reference example (S023). To explain it specifically, when forming the nozzle check patterns NP relating to each of the nozzles of the 4 CMYK colors, the controller 60 directly lands ink ejected from each of the nozzles on the test sheet TS. For example, when the nozzle check pattern NP (K) relating to the black ink nozzle is formed, the black ink ejected from the black ink nozzle is directly landed on the test sheet TS.

On the other hand, when the controller 60 forms the nozzle check pattern NP (W) relating to the white ink nozzle (YES in S022), it is difficult for a user to visually recognize the nozzle check pattern NP (W) relating to the white ink nozzle, if the controller directly lands white ink ejected from the white ink nozzle on the test sheet TS. Consequently, in the nozzle check pattern forming process of the embodiment, ink of another color are landed prior to the landing of the white ink, and then white ink is landed on the ink of the other color, to thereby form the nozzle check pattern NP (W) relating to the white ink nozzle.

To explain it specifically, the controller 60 lands black ink ejected from the nozzle black ink in the predetermined unit region on the test sheet TS (S024). Here, the predetermined unit region is a unit region corresponding to the pixel data constituting the image data of the nozzle check pattern NP (W) relating to the white ink nozzle. As a result, as shown in FIG. 11A, the underlying pattern UG constituted by black ink is formed on a region on which the check pattern NP (W) relating to the white ink nozzle is originally formed. Later, white ink is overstriked on the underlying pattern UG, so that the nozzle check pattern NP (W) relating to the white ink nozzle is formed. That is, the underlying pattern UG is an underlying portion for forming the nozzle check pattern NP (W) relating to the white ink nozzle.

The underlying pattern UG will be described in detail with reference to FIG. 11A. The underlying pattern UG has substantially the same shape as that of the nozzle check pattern NP, and is constituted by the underlying pieces UP having the same number as that of the nozzle holes constituting the white ink nozzle. In the underlying portion pattern UG, each of the underlying pieces UP are lined up in substantially the same way of lining as those of each of blocks BP in the nozzle check patterns NP. To explain it specifically, the rectangular-shaped underlying pieces UP are lined up in steps in the number of m in the direction equivalent to the movement direction of the head 23, and lined up in the number of n for each regular interval along the direction equivalent to the transport direction.

Further, focusing attention on each of the underlying pieces UP, each of the underlying pieces UP is composed of the dots formed by black ink which are landed in the predetermined unit region on the test sheet TS (hereinafter, dots of black ink). In the embodiment, as shown in FIG. 12A, a landing amount of black ink in the predetermined unit region (that is to say, eject amount) is set to have the dots of black ink as small dots.

After the underlying pattern UG is formed, the controller 60 lands white ink on each of the underlying pieces UP of the underlying portion pattern UG, and thereby forms the nozzle check pattern NP (W) relating to the white ink nozzle (S025). In other words, in the embodiment, after black ink ejected from the black ink nozzle is landed on the test sheet TS, the controller 60 superimposedly lands (overstrikes) white ink ejected from the nozzle white ink on the black ink, and thereby forms the nozzle check pattern NP (W) relating to the white ink nozzle.

Here, white ink is not mixed with ink of other colors, as described above. If white ink is overstriked on ink of other colors, the color of a part where the ink of other colors and white ink overlap is repainted from the other colors mentioned above to a white color. In other words, on a part where white ink is superimposed among the dots of black ink constituting the underlying pattern UG, the dots (hereinafter, dots of white ink) are formed by white ink landed on the black ink. As a result, each of the blocks BP (W), which constitutes the nozzle check pattern NP composed of the dots of white ink (that is, nozzle check pattern NP (W) relating the white ink nozzle), is formed on each of the underlying pieces UP.

In other words, in the nozzle check pattern forming process of the embodiment, similarly to reference example, the nozzle check pattern NP (W) relating to the white ink nozzle is formed by white ink ejected from the white ink nozzle which is a check object nozzle (that is to say, it is printed with white ink).

In addition, the nozzle check pattern NP (W) relating to the white ink nozzle is a rectangular shape, similarly to the nozzle check pattern NP relating to the nozzles of other ink colors, and is constituted by the blocks BP(W) having the same number as that of the nozzle holes constituting the white ink nozzle. In the nozzle check pattern NP (W), each of the blocks BP (W) is lined up in steps in the direction equivalent to the movement direction of the head 23, and is lined up for each regular interval along the direction equivalent to the transport direction. Further, each of the blocks BP (W) constituting the nozzle check pattern NP (W) corresponds to each of the nozzle holes constituting the white ink nozzle. The correspondence relationship between each of the blocks BP (W) and the white ink nozzle holes is the same as the above-described correspondence relationship.

In addition, in the embodiment, the controller 60 forms the nozzle check pattern NP (W) relating to the white ink nozzle on the underlying pattern UG so as to have the same shape and size as those of the underlying pattern UG. That is to say, the underlying pattern UG is an underlying portion having the same pattern as the nozzle check pattern NP (W) relating to the white ink nozzle formed thereon. The controller 60 forms a pattern that blots out the underlying pattern UG as the nozzle check pattern NP (W) relating to the white ink nozzle. As a result, the dots formed in the predetermined unit region on the test sheet TS (the dots formed in the unit region corresponding to the pixel data constituting image data of the nozzle check pattern NP (W) relating to the white ink nozzle) change from the black ink dots to the white ink dots.

To explain it more specifically, the controller 60 lands the above-described white ink so that the white ink dot becomes a medium dot when it forms white ink dots by landing the white ink on each black ink dot constituting the underlying pattern UG (more particularly, each underlying piece UP). That is, the controller 60 forms the white ink dots to be larger than the black ink dots. Herewith, as shown in FIG. 12B, if a white ink dot is formed on a black ink dot, the white ink dot blots out the above-described black ink dot. Accordingly, as shown in FIG. 11B, the nozzle check pattern NP (W) relating to the white ink nozzle blots out the underlying pattern UG. More specifically, each block BP (W) constituting the nozzle check pattern NP (W) blots out a corresponding underlying piece UP among a plurality of underlying pieces UP constituting the underlying pattern UG.

Meantime, the landing amount (that is to say, ejection amount) of the above-described white ink landed and superimposed on the black ink, is setup so that the white ink dots are medium dots in the embodiment. However, the landing amount is not limited thereto. The controller 60 may form each ink dot having other size than the above-described one as long as the white ink dot is larger than the black ink dot (for example, each dot may be formed so that the black ink dot becomes a medium dot, and the white ink dot becomes a large dot).

By the procedure described above, the controller 60 repeats the dot forming operation and the transport operation in accordance with the print data received from the printer driver 111, and forms the nozzle check pattern NP for each ink color. The nozzle check pattern forming process finishes at the point in time (S026) when the dot forming operation and the transport operation have been repeated until there are no more above-described print data.

At the point when the nozzle check pattern forming process has finished, the nozzle check patterns of five colors, i.e., NP (K), NP (C), NP (M), NP (Y) and NP (W) are formed on the test sheet TS. As shown in FIG. 11B, the nozzle check patterns of five colors, i.e., NP (K), NP (C), NP (M), NP (Y) and NP (W) are located in the substantially same position in the direction equivalent to the transport direction, and are lined up in the order shown in FIG. 11B from one end side in the direction equivalent to the movement direction of the head 23. However, the positions where the nozzle check patterns NP (K), NP (C), NP (M), NP (Y) and NP (W) are formed are not limited to the above-described positions.

### Nozzle Check Method of the Embodiment

After the end of the nozzle check pattern forming process, a user performs the nozzle check using each of the nozzle check patterns NP formed on the test sheet TS (that is, confirmation whether or not the nozzle is in the state of poor ink ejection). Hereinafter, the check method of the embodiment will be explained.

The 4 CMYK color nozzles, among the five-color nozzles, are checked by visually recognizing corresponding nozzle check pattern NP in the procedure similar to the nozzle check method using the nozzle check pattern NP formed in the reference examples. The white ink nozzle is checked by a procedure different from that of the CMYK color ink nozzles. To explain it specifically, when the nozzle check pattern NP (W) relating to the white ink nozzle blot outs the underlying pattern UG, the white ink nozzle is determined to be normal. That is to say, when the underlying pattern UG is not visually recognized within the range that the nozzle check pattern NP (W) relating to the white ink nozzle is formed on the test sheet TS, the white ink nozzle is determined to be normal.

On the contrary, when the nozzle check pattern NP (W) relating to the white ink nozzle does not blot out the underlying pattern UG, white ink nozzle is determined as being in a state of poor ink ejection. In other words, when block BP (W) that does not blot out the underlying pattern UG (more particularly, underlying piece UP) exists in the nozzle check pattern NP (W), it is determined that the nozzle omission is generated in the white ink nozzle hole corresponding to the block BP (W).

Meantime, a case may be supposed where the nozzle from which the ink constituting the underlying pattern UG is ejected (black ink nozzle in the embodiment) is in the state of poor ink ejection. Considering this point, in a case where the white ink nozzle is checked by the procedure described above, it is preferred that confirmation is performed in advance for the fact that the nozzle from which the ink constituting the underlying pattern UG is ejected is in the state of normal (a state where ink can be appropriately ejected), and then the nozzle check pattern NP (W) relating to the white ink nozzle is formed. Alternatively, each underlying piece UP of the underlying pattern UG may be also formed by an ink ejected from a plurality of different nozzle holes. In addition, each underlying piece UP may be formed so as to have the size slightly larger than the above-described block BP (W) corresponding to each underlying piece UP, among the blocks BP (W) that the nozzle check pattern NP (W) relating to the white ink nozzle has. Thereby it becomes easy to determine whether or not the underlying pattern UP is appropriately formed. If the solution as described above is taken, check relating to the white ink nozzle is appropriately performed by the above-described procedure.

When one or more color nozzles among the five color nozzles are determined as being in a state of poor ink ejection in the nozzle check method performed by the procedure described above, a user requests execution of the cleaning operation to the controller 60 of the printer 10 via the printer driver 111 by clicking the cleaning button 122b of the utility screen 122 (see FIG. 7). In such a case, the controller 60 executes the above-described cleaning operation in response to a user request.

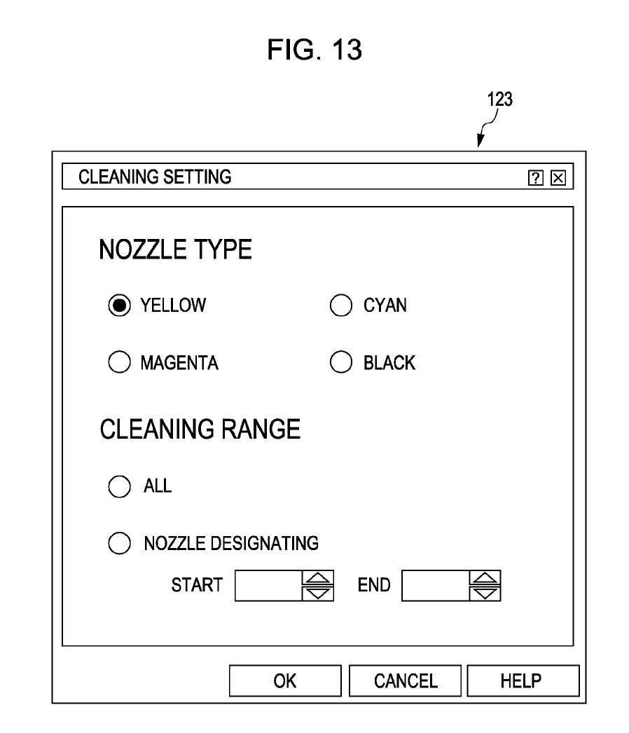

Meantime, in the cleaning operation of the embodiment, all of the nozzles formed on the nozzle surface of the head 23 are cleaned (in other words, forcible discharge of ink is executed for all of the nozzles). However, the cleaning operation is not limited thereto. The cleaning operation may be executed for the nozzle in the state of poor ink ejection among the five color nozzles. Alternatively, the cleaning operation may be executed only for the nozzle hole determined that the nozzle omission is generated. To explain it specifically, for example, it is also possible that a user clicks the above-described cleaning button 122b, whereby the printer driver 111 displays the cleaning setting screen 123 as shown in FIG. 13, and the user executes the cleaning operation in accordance with the set conditions (the kind of the nozzle that is the object of the cleaning operation, and the range of the nozzle hole). FIG. 13 is a view showing the cleaning setting screen 123.

After the execution of the cleaning operation, a user executes again the nozzle check pattern forming process to the controller 60 of the printer 10 as above-described, and repeatedly executes the cleaning operation and the nozzle check pattern forming process until the poor ink ejection of the nozzle is visually recognized as certainly solved.

Meantime, it is preferred that the black ink nozzle ejecting the black ink constituting the underlying pattern UG is checked in advance before the underlying pattern UG is formed in forming the above-described underlying pattern UG in the nozzle check pattern forming process.

### With Respect to Effectiveness of the Printer 10 of the Embodiment

As described above in the embodiment, out of a first nozzle and a second nozzle from which a first liquid and a second liquid having colors different from each other are ejected, the controller 60 lands the second liquid ejected from the second nozzle on the test sheet TS. Then, the controller 60 lands the first liquid ejected from the first nozzle on the second liquid. Then, the controller 60 forms the nozzle check pattern NP constituted by the above-described first liquid in order to check the poor liquid ejection of the first nozzle.

Herein, the first liquid according to the embodiment is an ink of a color that is closer to the ground color of the test sheet TS among the five color inks, and the nozzle ejecting the ink is equivalent to the first nozzle. When a white paper is the test sheet TS as in the embodiment, white ink is equivalent to the first liquid, and the white ink nozzle is equivalent to the first nozzle. On the other hand, the second liquid, is an ink of a color different from that of the above-described first liquid among the five color inks, and the nozzle ejecting this ink is the second nozzle. The second liquid is an ink for which the contrast of the color to the ground color of the test sheet TS is larger than the contrast of the first liquid color to the ground color. Meantime, relating to the second liquid, it is desirable for the contrast of the second liquid color to the above-described ground color to be large. When the test sheet TS is a white paper as in the embodiment, a black ink is suitable as the second liquid (That is to say, the black ink nozzle is an example of the second nozzle).

As described above in the embodiment, in forming the nozzle check pattern NP (W) in order to check poor ink ejection of the white ink nozzle that is the first nozzle, the black ink ejected from the black ink nozzle that is the second nozzle is landed on the test sheet TS. Thereafter, the white ink is landed on the black ink landed on the test sheet TS so as to form the nozzle check pattern NP (W) constituted by the white ink.

In other words, in order to form the above-described nozzle check pattern NP (W) in the embodiment, the white ink is not directly landed on the test sheet TS, but landed with the intervention of a black ink between the white ink and the test sheet TS. That is to say, the nozzle check pattern NP (W) constituted by the white ink is configured so as to be formed on the underlying portion (the underlying pattern UG in the above-mentioned description). As a result of forming the above-described nozzle check pattern NP (W) on such underlying portion, it becomes possible to easily determine whether or not the nozzle check pattern NP (W) is normally formed.

To explain it specifically, in the above-mentioned description, the nozzle check pattern NP (W) relating to the white ink nozzle is composed of white ink dots (dots of the first liquid), and the underlying pattern UG is composed of black ink dots (dots of the second liquid). The nozzle check pattern NP (W) is formed to blot out the underlying pattern UG. As a result, in a case where the nozzle check pattern NP (W) blot out the underlying pattern UG, the nozzle check pattern NP (W) is normally formed, and it is determined that the white ink nozzle is in the state of normal. On the contrary, in a case where the nozzle check pattern NP (W) does not blot out a part or the whole of the underlying pattern UG (that is, a case where the underlying pattern UG is visually recognized), the nozzle check pattern NP (W) is not normally formed, and it is determined that the white ink nozzle is in a state of poor ink ejection.

Herein, since the black is a color having large contrast to the test sheet TS, it is easy for a user to confirm whether or not the underlying pattern UG is blotted out. For this reason, it becomes also easy to determine whether or not the nozzle check pattern NP (W) relating to the white ink nozzle is normally formed, that is, whether or not the white ink nozzle is in a state of poor ink ejection. As a result, also in a case where the nozzle check pattern NP (W) constituted by the white ink is formed on the test sheet TS of which the ground color is the white, it becomes possible to appropriately check poor ink ejection of the white ink nozzle using the nozzle check pattern NP (W).

### With Respect to the Modified Example of the Nozzle Check pattern Forming Process

In the above-mentioned embodiment, it has been explained an example where an underlying portion having the same pattern as the nozzle check pattern NP (W) constituted by the black ink, that is, the underlying pattern UG is formed, and then the nozzle check pattern NP (W) that blot outs the underlying pattern UG by the white ink is formed (hereinafter, referred to as the example of the invention). In the example of the invention, poor ink ejection of the white ink nozzle is checked by visually recognizing whether or not the underlying pattern UG is blotted out. However, relating to the check method using the underlying portion, and the nozzle check pattern NP formed on the underlying portion, not only the example of the invention, but other examples (hereinafter, referred to as the modified example) are also conceivable.

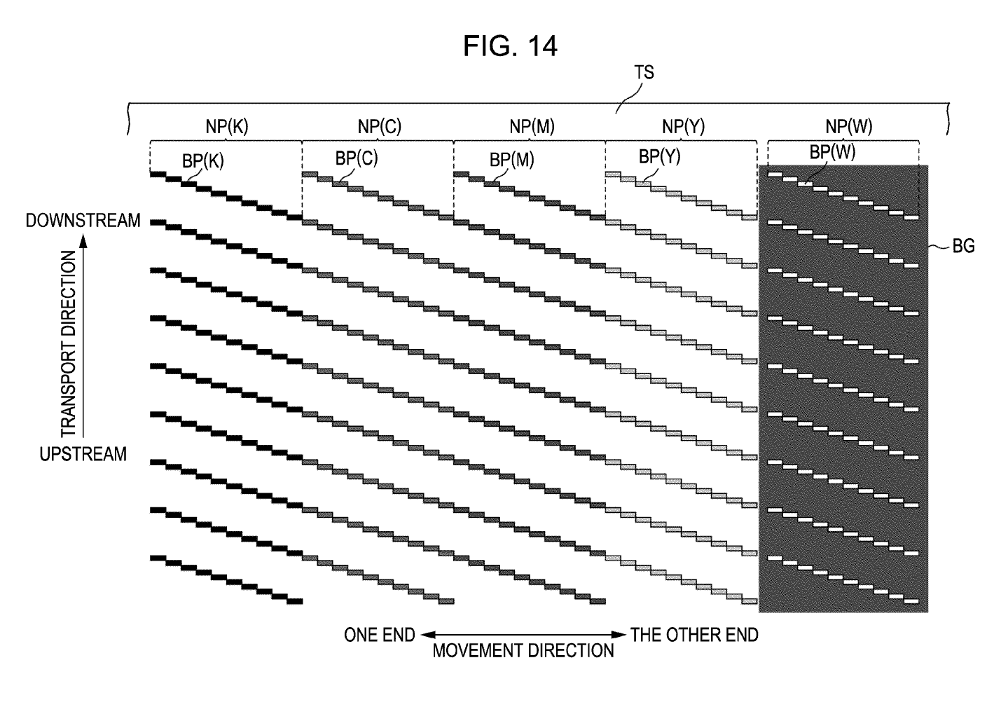

Hereinafter, with reference to FIG. 14, the modified example of the nozzle check pattern forming process will be explained. FIG. 14 is a view showing a background image BG and the nozzle check pattern NP (W) relating to the white ink nozzle which are formed in the nozzle check pattern forming process according to the modified example. In the explanation below, descriptions duplicating those of the example of the invention are omitted.

In the nozzle check pattern forming process according to the present modified example, the black ink ejected from the black ink nozzle is landed on the test sheet TS so as to form the underlying portion constituted by the black ink in advance before the nozzle check pattern NP (W) relating to the white ink nozzle is formed. Then, the white ink is landed on the underlying portion so as to form the nozzle check pattern NP (W) constituted by the white ink. From this point of view, the present modified example has something in common with the example of the invention.

On the other hand, in the nozzle check pattern forming process according to the present modified example, the controller 60 performs a solid setting of the black ink in predetermined region of the test sheet TS so as to form the background image BG constituted by the black ink on the above-described test sheet TS. Herein, regarding the predetermined region, it is a region of substantially rectangular shape that surrounds the nozzle check pattern NP (W) when the nozzle check pattern NP (W) relating to the white ink nozzle is formed. The background image BG formed in the predetermined region is an example of the underlying portion constituted by the black ink, and has the shape and size similar to those of the above-described predetermined region.

After forming this background image BG, the controller 60 lands the white ink ejected from the white ink nozzle on the background image BG so as to form the nozzle check pattern NP (W) relating to the white ink nozzle. Herein, each block BP (W) constituting the nozzle check pattern NP (W) is formed in a form of the floating island on the background image BG as shown in FIG. 14. That is, the nozzle check pattern NP (W) relating to the white ink nozzle formed in the present modified example is formed to be surrounded by the background image BG without fully blotting out the underlying portion.

Meantime, it is preferred that the black ink ejected from a plurality of the black ink nozzle holes is landed on the test sheet TS to form the above-described background image BG so as to avoid the influence of the case where nozzle omission is generated in a portion of the black ink nozzle hole when the background image BG is formed. In addition, in order to form nozzle check pattern NP (W) relating to the white ink nozzle on the background image BG, for example, a transport roller 33 may be rotated in the inverted direction after the background image BG is formed. Thereby the test sheet TS is transported from the downstream side to the upstream side up to the position where nozzle check pattern NP (W) relating to the white ink nozzle is formed on the above-described background image BG in the transport direction. Alternatively, after the background image BG is formed, the test sheet TS may be discharged, and the test sheet TS may be fed again into the printer 10.

By the procedure described above, the nozzle check pattern NP (W) relating to the white ink nozzle is constituted by block BP (W) in the same number as that of the nozzle holes constituting the white ink nozzle similarly to the case of the example of the invention. In addition, each block BP (W) has a rectangular shape, and is lined up in steps in the direction equivalent to the movement direction of the head 23, and further lined up for each regular interval along the direction equivalent to the transport direction.

After the nozzle check pattern NP (W) relating to the white ink nozzle is formed, it is configured that a user visually recognizes the nozzle check pattern NP (W) relating to the white ink nozzle in checking the white ink nozzle. At this time, a user compares the color of the background image BG (that is, black) with the color of the nozzle check pattern NP (W) relating to the white ink nozzle (that is, white). The nozzle check pattern NP (W) relating to the white ink nozzle is inconspicuous in a case where it is directly formed on a white test sheet TS which leads to difficulties for a user to visually recognize it. However, in a case where the nozzle check pattern NP (W) relating to the white ink nozzle is formed on the background image BG, it becomes noticeable so that it is easy for a user to visually recognize it. In other words, since the contrast is large of the color of the nozzle check pattern NP (W) relating to the white ink nozzle to the color of the background image BG, it becomes possible for a user to easily visually recognize the nozzle check pattern NP (W). Thereby it becomes possible for a user to appropriately check the poor ink ejection of the white ink nozzle.

As described above, in the present modified example, by forming the nozzle check pattern NP (W) relating to the white ink nozzle to be surrounded by the background image BG that is the underlying portion, the nozzle check pattern NP (W) becomes noticeable so that it becomes easy for a user to visually recognize it. Herewith, it becomes possible for a user to check the white ink nozzle with a procedure substantially similar to the case of checking the nozzle for other ink colors. From this point of view, the modified example is more preferable than the example of the invention.

On the other hand, in the example of the invention, the nozzle check pattern NP (W) relating to the white ink nozzle is formed to blot out the underlying pattern UG that is an underlying portion. That is to say, the underlying pattern UG is formed to be blotted out by the above-described nozzle check pattern NP (W). As a result, the consumption of the black ink required in order to form the underlying portion (the underlying pattern UG) in the example of the invention is less than the consumption of the black ink required in order to form the underlying portion (the background image BG) in the modified example. In other words, from the viewpoint of reducing the consumption of ink, the example of the invention is more preferable than the modified example. In addition, in the example of the invention, the controller 60 forms the white ink dots constituting the nozzle check pattern NP (W) to be larger than the black ink dots constituting the underlying pattern UG. Herewith, it becomes possible to further reduce the black ink consumption required in order to form the underlying portion.

### Other Embodiments

As described above, it has been explained the liquid ejecting apparatus, and the method of forming the nozzle check pattern according to the invention based on the above-described embodiment. However, the above-described embodiment of the invention is intended to easily illustrate the invention, and not intended to limit the invention. The invention can by modified or improved without departing from the spirit of the invention, and of course encompasses the equivalence of the invention.

In addition, the above-described embodiment has been explained with an example of a case where the first liquid is an white ink, the second liquid is a black ink (in other words, the first nozzle is an white ink nozzle and the second nozzle is a black ink nozzle), and the nozzle check pattern NP (W) constituted by the white ink is formed on a white test sheet TS. However, the first liquid, the second liquid, and the ground color of the test sheet TS are not limited to those of the above-described embodiment. They may be of other colors as long as the contrast of the second liquid color to the ground color of the test sheet TS is large when compared with the contrast of the first liquid color to the ground color of the test sheet TS.

For example, in a case where the first liquid is white ink, and the nozzle check pattern NP (W) constituted by white ink is formed on a white test sheet TS, magenta ink may be used as the second liquid. That is, the magenta ink may be landed on the white test sheet TS, and then the white ink may be landed on the magenta ink, to form the nozzle check pattern NP (W) constituted by the white ink.

In addition, when the first liquid is black ink, and the nozzle check pattern NP (K) constituted by the black ink is formed on the test sheet TS of black color, the ink used as the second liquid is suitably white ink. That is, if the white ink is landed on the test sheet TS of black color, and then the black ink is landed on white ink, to form the nozzle check pattern NP (K) constituted by the black ink, it becomes possible for a user to appropriately check the above-described poor ink ejection of the nozzle ejecting black ink.

In addition, in the above-described embodiment, the 4 CMYK color nozzles and the white ink nozzle have been formed on the nozzle surface of the head 23. However, further formed on the nozzle surface may be a nozzle ejecting light cyan (LC) ink, a nozzle ejecting light magenta (LM) ink, a nozzle ejecting light yellow (LY) ink, a nozzle ejecting dark yellow (DY) ink, a nozzle ejecting light black (LK) ink and the like. In a case where the nozzle check pattern NP for one nozzle (first nozzle) of the above-described nozzles is formed on the test sheet TS of color that is close to the color of the ink ejected from the nozzle (the first liquid), color ink having a larger contrast to the ground color of the test sheet TS may be the second liquid, and the ink-ejected nozzle may be the second nozzle.

In addition, in the above-described embodiment, it has been explained the printer 10 (so-called serial printer) having the head 23 moving in the movement direction. However, the printer is not limited thereto. For example, a printer may be also used in embodying the invention, which has the head 23 that is not movable, but placed in a stationary position, and can form at a time a plurality of dots lined up in the direction intersecting with the transport direction of medium S (so-called line printer).

In addition, in the above-described embodiment, it has been explained the printer 10 ejecting ink to form an image as an example of the liquid ejecting apparatus. However, the liquid ejecting apparatus is not limited thereto, and may be embodied as a liquid ejecting apparatus ejecting other liquids than ink (in addition to liquid, including a liquid form wherein particles of a functional material are dispersed, and a liquid forms such as gel).

For example, the liquid ejecting apparatus may be a liquid ejecting apparatus ejecting liquid including a dispersed or dissolved form of a material such as an electrode material, a color material and the like used in the manufacture of liquid crystal display, EL (electroluminescence) display and plane emission display, and the like; a liquid ejecting apparatus ejecting a bioorganic substance used in biochip manufacture; and a liquid ejecting apparatus ejecting liquid that is a sample used as a precision pipette. Furthermore, the liquid ejecting apparatus may be a liquid ejecting apparatus ejecting lubricating oil at a pinpoint to a precision machine such as a watch and a camera; a liquid ejecting apparatus ejecting on a substrate, a transparent resin liquid such as ultraviolet curable resin substrate in order to form a micro-semispherical lens (optical lens) and the like used in an optical communication device and the like; a liquid ejecting apparatus ejecting etching liquid such as an acid or alkaline in order to etch a substrate and the like; and liquid form eject apparatus ejecting gel. The invention can be applied to any one kind of these liquid ejecting apparatus.

What is claimed is:

1. A liquid ejecting apparatus, comprising:
a head that ejects a first liquid and a second liquid having colors different from each other on a medium from a first nozzle and a second nozzle; and
a control section that forms a nozzle check pattern constituted by the first liquid for checking poor liquid ejection from the first nozzle by landing the second liquid ejected from the second nozzle on the medium, and then landing the first liquid ejected from the first nozzle on the second liquid.

2. The liquid ejecting apparatus according to claim 1, wherein the medium is a white paper, and
wherein the first liquid is a white liquid.

3. The liquid ejecting apparatus according to claim 1, wherein the control section forms an underlying portion constituted by the second liquid and having the same pattern as the nozzle check pattern by landing the second liquid ejected from the second nozzle on the medium, and then
forms the nozzle check pattern blotting out the underlying portion by landing the first liquid ejected from the first nozzle on the underlying portion.

4. The liquid ejecting apparatus according to claim 3, wherein the nozzle check pattern is composed of dots of the first liquid ejected from the first nozzle,
wherein the underlying portion is composed of dots of the second liquid ejected from the second nozzle, and
wherein the control section forms the dots of the first liquid to be larger than the dots of the second liquid.

5. The liquid ejecting apparatus according to claim 1, wherein the control section forms the underlying portion constituted by the second liquid by landing the second liquid ejected from the second nozzle on the medium, and then
forms the nozzle check pattern surrounded by the underlying portion by landing the first liquid ejected from the first nozzle on the underlying portion.

6. A method of forming a nozzle check pattern, comprising:
landing a second liquid, which is ejected from a second nozzle out of a first nozzle and the second nozzle ejecting a first liquid and the second liquid having colors different from each other, on a medium, and
forming a nozzle check pattern constituted by the first liquid for checking poor liquid ejection of the first nozzle by landing the first liquid ejected from the first nozzle on the second liquid.
